(19) United States
(12) Patent Application Publication
(10) Pub. No.: US 2016/0105652 A1
(43) Pub. Date: Apr. 14, 2016

(54) PROJECTION TYPE DISPLAY APPARATUS AND CONTROL METHOD FOR PROJECTION TYPE DISPLAY APPARATUS

(71) Applicant: NEC DISPLAY SOLUTIONS, LTD., Tokyo (JP)

(72) Inventor: Eisuke YAMASHITA, Tokyo (JP)

(21) Appl. No.: 14/778,542

(22) PCT Filed: Mar. 27, 2013
(86) PCT No.: PCT/JP13/59036

§ 371 Date: Sep. 18, 2015

(51) Int. Cl. H04N 9/31; G02B 26/00

(52) U.S. Cl. CPC H04N 9/3144; H04N 9/3111; H04N 9/3155; G02B 26/008

(57) ABSTRACT

A color wheel includes a plural of transmission areas (R, G, B, C, W and Y) on which light from a light source is made incident and which each transmit light of a different wavelength. A detector detects ambient information. A power supplier supplies power to the light source. A controller controls the supply power to be supplied to the light source by the power supplier. The transmission areas (R, G, B, C, W and Y) on which light from the light source is made incident are sequentially changed. When the ambient information satisfies a predetermined condition, the controller changes the supply power in synchrony with the transmission areas (R, G, B, C, W and Y).

### TECHNICAL FIELD

The present invention relates to a projection type display apparatus and a control method for a projection type display apparatus.

### BACKGROUND ART

Since the parts that are arranged on a optical path of light that is emitted from a lamp that are used in a projection type display apparatus are heated by irradiation, the temperature of the individual parts may rise. Since there is a risk that such temperature rise of the parts may cause the projector to malfunctions, failures and the like, the projection type display apparatus generally uses a cooling fan to cool these parts.

As the rotational rate of the cooling fan increases, so too does the cooling capacity. However, since the higher the rotational rate of the cooling fan, the higher is the operation noise, the rotational rate of the cooling fan is usually set so that the interior temperature of the projector is kept at a target level. For example, the rotational rate of the cooling fan is set to become higher as the difference between the interior temperature of the projector and the target temperature becomes larger (see Patent Document 1).

However, in some circumstances, the efficiency of cooling the parts by the cooling fan may become lower and the fan cannot provide a sufficient cooling effect even if the rotational rate of the cooling fan is maximized. For example, in a hot environment where the ambient temperature is high, even if air is blown onto the heated parts, there is a small temperature difference between the parts and the air, so that heat transfer is poor, which results in low cooling efficiency.

Alternatively, in an environment where the air is thin as in a highland area, since the air that performs heat exchange with the parts is so thin, heat transfer is poor. Thus, even if the air is blown onto the heated parts, the cooling efficiency becomes lower. Moreover, when the cooling capacity of the cooling fan has degraded due to aging, clogging due to dust or for other reasons, the air flow rate of the cooling fan becomes lower, which also results in low cooling efficiency.

Patent Document 2 discloses a technology in which temperature rise of the optical parts is prevented by lowering the intensity of light incident on the optical parts on the optical path when the cooling capacity of the cooling fan is insufficient even at the maximum rotational rate. The examples of the method of lowering the intensity of light incident on the optical parts include a method in which a shading member that has a plurality of opening/closing shading slats is arranged on the optical path such that part of light is shaded, and a method in which the driving power for driving the lamp is reduced by a certain ratio.

### RELATED ART DOCUMENTS

### Patent Documents

Patent Document 1: JP2008-227127A

Patent Document 2: JP2010-091882A

### SUMMARY OF THE INVENTION

### Problems to be Solved by the Invention

However, in the method in which the light intensity is reduced by using the shading member, since part of light is shaded by the shading member, the distributed intensity of light that reaches the display device becomes different depending on location, whereby luminance unevenness may occur in the projected image. Further, this method also involves the problem of increase in cost that results adding the shading member.

Further, in the method in which the driving power of the lamp is reduced by a certain ratio, the life of the light source may be shortened if the driving power of the lamp is continuously kept lower than the predetermined power for a long period of time.

The object of the present invention is to provide a projection type display apparatus, as well as a control method for a projection type display apparatus, which can reduce defects in the optical parts that occur due to an increase in temperature while preventing the occurrence of luminance unevenness and preventing a reduction in the life cycle of the lamp.

### Means for Solving the Problems

A projection type display apparatus according to the present invention includes:

a light source;

a light separation device that includes a plurality of transmission areas on which light from the light source is made incident and which each transmit light of a different wavelength;

a detector that detects ambient information;

a power supplier that supplies power to the light source; and

a controller that controls a supply power to be supplied to the light source by the power supplier, wherein

the transmission areas, on which light from the light source is made incident, are sequentially changed, and

when the ambient information satisfies a predetermined condition, the controller changes the supply power in synchrony with the plurality of transmission areas.

A control method for a projection type display apparatus according to the present invention, includes:

emitting light from a light source;

making the light incident on a light separation device that includes a plurality of transmission areas that each transmit light of a different wavelength;

sequentially changing the transmission areas on which light from the light source is made incident; and

changing a power that is supplied to the light source in synchrony with the transmission areas, based on ambient information detected by the a detector.

### Effect of the Invention

According to the present invention, it is possible to reduce defects in optical parts that occur due to an increase in temperature while preventing the occurrence of luminance unevenness and preventing a reduction in the life cycle of the lamp.

### BRIEF DESCRIPTION OF THE DRAWINGS

FIG. 1

A block diagram showing a configuration of a projector according to the first exemplary embodiment of the present invention.

FIG. 2

A diagram showing a configuration of a color wheel provided for the projector of FIG. 1.

FIG. 3

A chart showing the relationship between the transmission areas of incident light output from a lamp and the intensity of light output from the lamp when a high-luminance pattern is selected as a power level changing pattern.

FIG. 4

A chart showing the relationship between the transmission areas of incident light output from a lamp and the intensity of light output from the lamp when a low-luminance pattern is selected as a power level changing pattern.

FIG. 5

A flow chart for explaining a switching process of power level changing patterns in a projector according to the present exemplary embodiment.

FIG. 6

A flow chart for explaining a switching process of power level changing patterns in a projector according to the second exemplary embodiment of the present invention.

### MODE FOR CARRYING OUT THE INVENTION

Now, the exemplary embodiment of the present invention will be described with reference to the accompanying drawings. It should be noted that, in the description and the drawings, components that have the same functions are allotted with the same reference numeral so that repeated description may be omitted.

### First Exemplary Embodiment

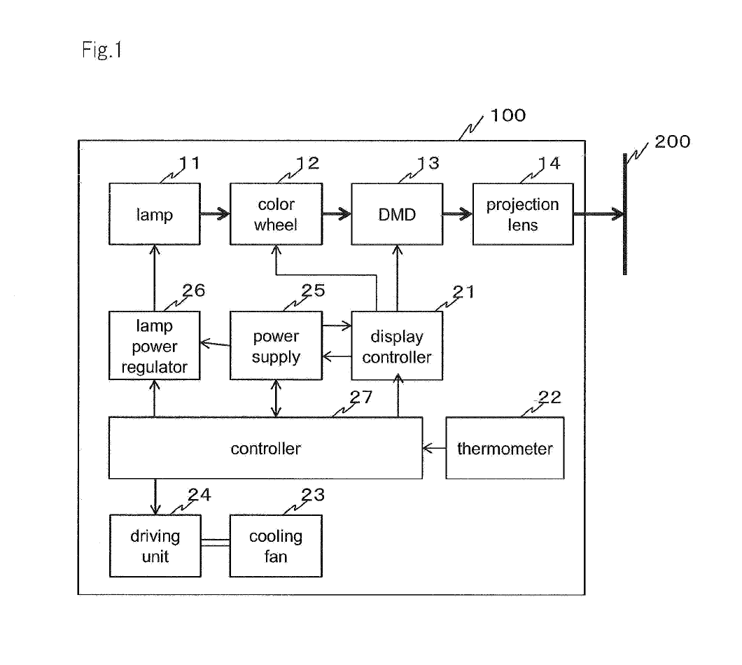

FIG. 1 is a block diagram showing a configuration of projector 100 according to the first exemplary embodiment of the present invention.

Projector 100 shown in FIG. 1 is a projection type display apparatus including lamp 11, color wheel 12, DMD (Digital Micromirror Device) 13, projection lens 14, display controller 21, thermometer 22, cooling fan 23, driving unit 24, power supply 25, lamp power regulator 26, and controller 27.

Lamp 11 is an example of a light source that emits multiple wavelengths of light, e.g., a white light source.

Color wheel 12 having a disc shape includes a plurality of transmission areas that each allow a different wavelength of light to pass through. In color wheel 12, transmission areas on which light from lamp 11 is incident are changed by rotating the wheel turns. Thus, color wheel 12 separates the light emitted from lamp 11 into multiple colors of light in a time-divisional manner. That is, color wheel 12 is a light separation device.

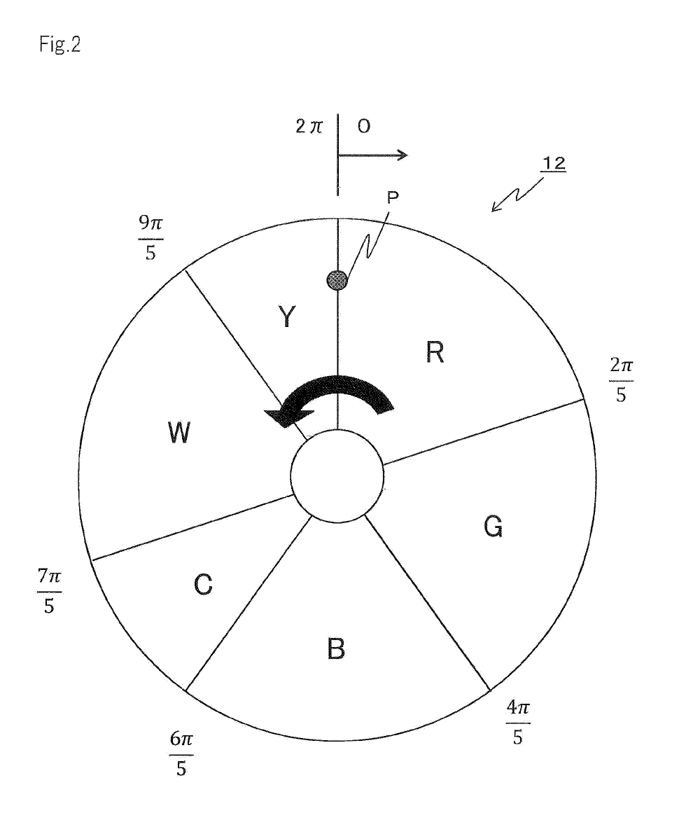

FIG. 2 is a diagram showing an example of a configuration of transmission areas of color wheel 12 provided for projector 100. Color wheel 12 has sectoral transmission areas each transmitting a different wavelength of light from others. In the present exemplary embodiment, color wheel 12 includes red transmission area R, green transmission area G, blue transmission area B, cyan transmission area C, white (transparent) transmission area W, and yellow transmission area Y Color wheel 12 is a disc in which sectoral transmission areas are joined. Each of red transmission area R, green transmission area G, blue transmission area B, white (transparent) transmission area W occupies one fifth of the disc, whereas cyan transmission area C and yellow transmission area Y each occupy one tenth of the disc.

Color wheel 12 is axially rotated about the center of the disc by an unillustrated motor. Light from lamp 11 is incident on a predetermined position on color wheel 12. FIG. 2 shows incident point P on which light from lamp 11 is incident. As color wheel 12 turns, this incident point P moves from one transmission area to another. For example, in FIG. 2, when the disc turns counterclockwise, incident point P moves in the sequence of red transmission area R, green transmission area G, blue transmission area B, cyan transmission area C, white transmission area W and yellow transmission area. As a result, at least part of the incident light is transmitted through each transmission area in accordance with the transmission characteristic of the transmission area and output from color wheel 12. Thereby, color wheel 12 separates light from lamp 11 and outputs multiple colors of light in a time divisional manner.

DMD 13 is an image forming unit in which light that is transmitted through color wheel 12 is used to form an image, and is an image forming element in which micro mirrors are arranged in a matrix. DMD 13 outputs image light that forms an image according to a video signal. Specifically, DMD 13 receives a colored light output from color wheel 12 and spatially modulates the colored light to output it as image light. More specifically, each mirror of DMD 13 corresponds to one pixel, and an angle of each mirror relative to the incident light is set to an ON state or OFF state in accordance with the video signal. The light reflected by the mirrors in the ON state propagates to projection lens 14. On the other hand, the light reflected by the mirrors in the OFF state goes in the different direction other than toward projection lens 14. Color tone is provided by switching between the ON state and the OFF state in high speed and by changing the ratio of time between the ON state and the OFF state.

Projection lens 14 enlarges and projects the image display plane of DMD 1 on screen 200.

Display controller 21 controls color wheel 12, DMD 13 and others to form an image in accordance with the video signal. Specifically, display controller 21 sequentially generates image data that represent luminance values of red R, green G, blue B, cyan C, white W and yellow Y, from the video signal in every frame of the video signal, and outputs the sequence of image data to DMD 13 in synchronization with the rotation of color wheel 12. Display controller 21 also controls the ratio between the durations of the ON state and the OFF state in each mirror of DMD 13 based on the video signal.

Thermometer 22 is an example of a detector that detects the ambient information that represents the interior or the surrounding condition of projector 100, and detects the temperature as the ambient information. Thermometer 22 may be arranged, for example, near the heat emitter such as lamp 11 or a part such as DMD 13 or the like that is heated by light emitted from lamp 11, or may be arranged at an upstream position of the flow of air flowing through the interior of the apparatus such as the vicinity of the intake port of the apparatus. Although use of one thermometer 22 is exemplified herein, projector 100 may include a plurality of thermometers 22.

Cooling fan 23 is a fan that cools the interior of projector 100 by blowing air into projector 100. Cooling fan 23 should be arranged at a position from which air can be blown toward the area where the temperature will rise. For example, cooling fan 23 is arranged at a position where air can be blown towards heating parts and parts arranged on the optical path in projector 100. Although use of one cooling fan 23 is exemplified herein, projector 100 may include a plurality of cooling fans 23.

Driving unit 24 turns cooling fan 23. Driving unit 24 includes a motor connected to the cooling fan and a rotational rate regulator that regulates the rotational rate of the motor. The rotational rate regulator amplifies or attenuates input power and outputs the resultant power to the motor to control the rotational rate of the motor. Since cooling fan 23 turns with rotation of the motor, the rotational rate of cooling fan 23 can be adjusted by adjusting the rotational rate of the motor.

Power supply 25 supplies power to each part of projector 100. Each part of projector 100 is driven by the power from power supply 25.

Lamp power regulator 26 is an example of a power supply unit that supplies power to lamp 11, and regulates the power level of the power output from power supply 25 and supplies the resultant power to lamp 11. Lamp power regulator 26 amplifies or attenuates the power to the level determined by controller 27 at a timing determined by controller 27.

Controller 27 is a control unit such as a CPU (Central Processing Unit) or the like, and controls display controller 21, thermometer 22, driving unit 24, power supply 25, lamp power regulator 26 and the like.

Controller 27 receives video signals from external devices such as unillustrated PCs (Personal Computer), USB (Universal Serial Bus) memories and the like to output the video signals to display controller 21.

Controller 27 also controls driving unit 24, power supply 25 and lamp power regulator 26 based on the temperature detected by thermometer 22. Specifically, controller 27, based on the temperature detected by thermometer 22, determines the rotational rate of cooling fan 23 and rotates the motor of driving unit 24 at the determined rotational rate. In this way, the airflow rate of cooling fan 23 is changed.

Further, controller 27 controls the power which lamp power regulator 26 supplies to lamp 11. In this process, controller 27 switches the level of the power to be supplied from lamp power regulator 26 to lamp 11 in synchronization with every transmission area of color wheel 12 on which light from lamp 11 is incident. Thereby, the instantaneous magnitude of the light intensity of the light that enters color wheel 12 can change so as to change the light intensity of the light incident on each transmission area on color wheel 12. Here in this description, the power level of the power supplied to lamp 11 during the period in which light is incident on each transmission area of color wheel 12 may be referred to as the power level corresponding to the transmission area.

Controller 27, based on the temperature detected by thermometer 22, changes the power level of the power supplied from lamp power regulator 26 to lamp 11 such that the intensity of light that enters each transmission area is changed in accordance with the temperature.

Specifically, controller 27, based on whether or not the temperature detected by thermometer 22 satisfies a predetermined condition, switches the changing pattern of power levels in one revolution of color wheel 12 so as to change the light intensity of the light incident on each transmission area. In the present exemplary embodiment, controller 27 determines that the predetermined condition is satisfied when the temperature detected by thermometer 22 exceeds a predetermined temperature. When the power level changing pattern is switched, the timings at which power level is changed and the power level at each timing that corresponds to the rotation of color wheel 12 change so that the light intensity of the light incident on each transmission area of color wheel 12 changes.

When the total amount of light that enters color wheel 12 during one revolution of color wheel 12 is constant, the total amount of light that passes through color wheel 12 becomes smaller as the light intensity of the light that enters the transmission area that has a higher light transmittance becomes lower. Therefore, when the temperature detected by thermometer 22 satisfies the predetermined condition, controller 27 reduces the total amount of light that passes through color wheel 12 by changing the power level so that the higher the transmittance of the transmission area is, the lower is the light intensity of the light that enters the transmission area.

In the present exemplary embodiment, controller 27 selects one pattern from among previously determined multiple changing patterns so as to change the changing pattern of the power to be supplied to lamp 11 and change the intensity of light to be incident on each transmission area.

In the present exemplary embodiment, the multiple changing patterns include a high-luminance pattern which puts importance on the brightness of the projected image and a low-luminance pattern which puts importance on stable operation of projector 100 when the temperature of projector 100 has been increased.

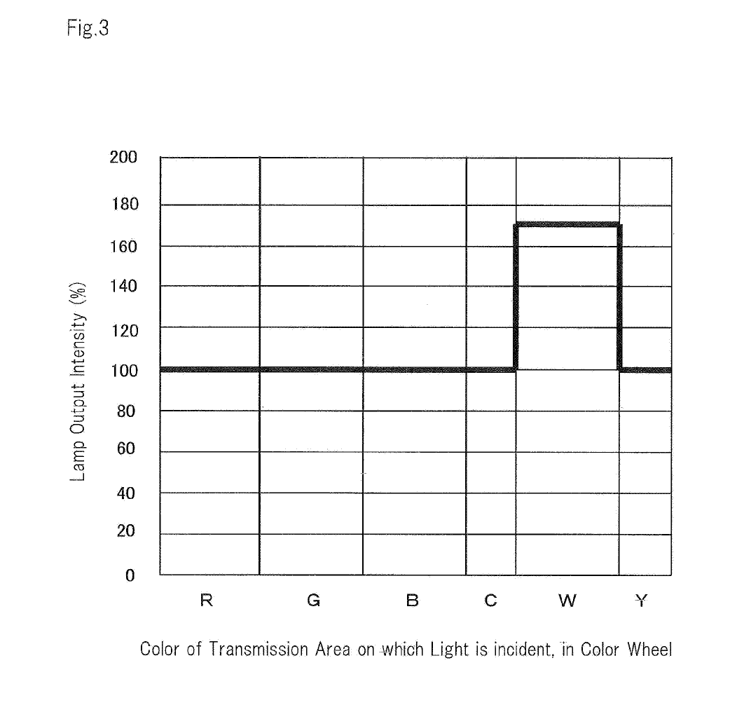

FIG. 3 is a chart showing the intensity of light emitted from lamp 11 when the power level of the power supplied to lamp 11 varies in accordance with the high-luminance pattern. In FIG. 3, 100% on the vertical axis corresponds to the average of the power supplied from power supply 25.

In the high-luminance pattern, lamp power regulator 26 raises the power level of the power supplied to lamp 11 during the period in which the light output from lamp 11 is incident on the transmission area of high transmittance. Accordingly, the intensity of light that enters the transmission area of high transmittance can be increased so that projector 100 can project a bright image.

Specifically, in the high-luminance pattern, lamp power regulator 26 causes the power level of the power that is to be supplied to lamp 11 to become higher during the period in which light output from lamp 11 is incident on white (transparent) transmission area W than the other periods. In the transmission areas that have lower transmittance than that of white transmission area W, such as red transmission area R and others, part of the light that enters the transmission area is shaded. In contrast, white transmission area W allows all the incident light to pass through without shading. Accordingly, by making the intensity of the light output from lamp 11 during the period in which the light output from lamp 11 is incident on white transmission area W higher than the intensity of the light output from lamp 11 during the period in which light is incident on the other transmission areas, it is possible to efficiently increase the total amount of light passing through color wheel 12.

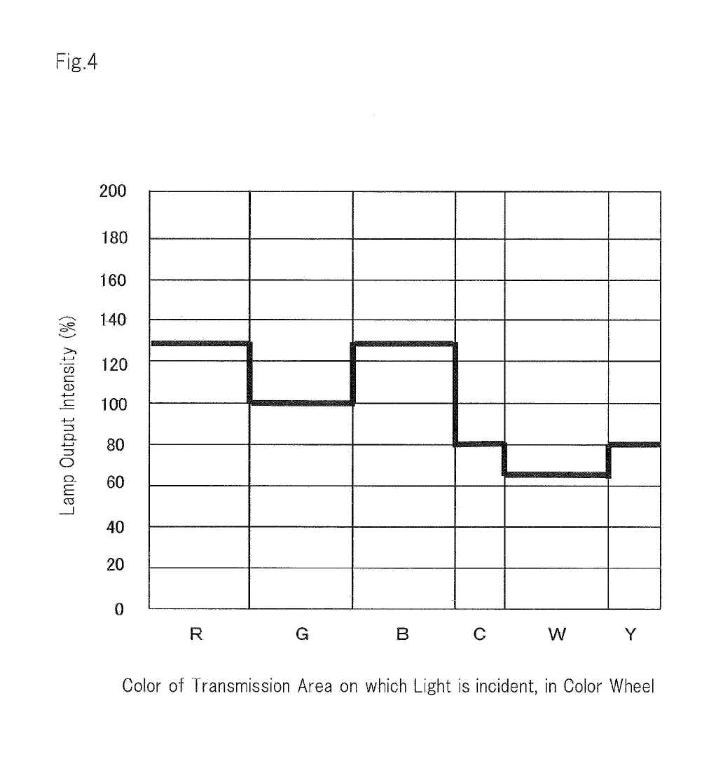

FIG. 4 is a chart showing the intensity of light emitted from lamp 11 when the power level of the power that is supplied to lamp 11 varies in accordance with the low-luminance pattern. In FIG. 4, similarly to FIG. 3, 100% on the vertical axis corresponds to the average of the power supplied from power supply 25.

In the case of the low-luminance pattern, the power level is adjusted by lamp power regulator 26 so as to be lower as the transmittance of the transmission area on which light from lamp 11 is incident becomes higher. According to this setting, the intensity of light that enters the transmission area of a high transmittance is reduced and the image projected by projector 10 becomes dimmer than that in the high-luminance mode, whereas it is possible to prevent an increase in the temperature of the optical parts. The highest transmittances of the transmission areas are, in sequence, red R, green G, yellow Y and white W, and red R and blue B have approximately the same level of transmittance. Cyan C and yellow Y also have approximately the same level of transmittance. That is, in the case of the low-luminance pattern, the relationship “red R=blue B>green G>cyan C=yellow Y>white W” holds as to the power levels of the power that is supplied to lamp 11 for different transmission areas on which light output from lamp 11 is incident. This relationship between power levels corresponds to the relationship between the transmittances of the transmission areas.

If the intensity of light incident on the transmission areas is lowered uniformly, the higher the transmittance of a transmission area, the greater is the decrease in the amount of light that passes through the transmission area. For example, if the intensity of light that enters each transmission area is 100, the intensity of light that passes through a transmission area having a transmittance of 100% is 100, whereas the intensity of light that passes through another transmission area having a transmittance of 50% is 50. Now, when the intensity of light that enters each transmission area is reduced to 50, the intensity of light that passes through the transmission area having a transmittance of 100% is 50, whereas the intensity of light that passes through the transmission area having a transmittance of 50% is 25. In this case, the decrease of the amount of light that passes through the transmission area having a transmittance of 100% is 50 and the decrease of the amount of light that passes through the transmission area having a transmittance of 50% is 25. In this way, by lowering the intensity of light output from lamp 11 during the period in which light is incident on the transmission area that has the higher transmittance, it is possible to efficiently decrease the total amount of light that passes through color wheel 12.

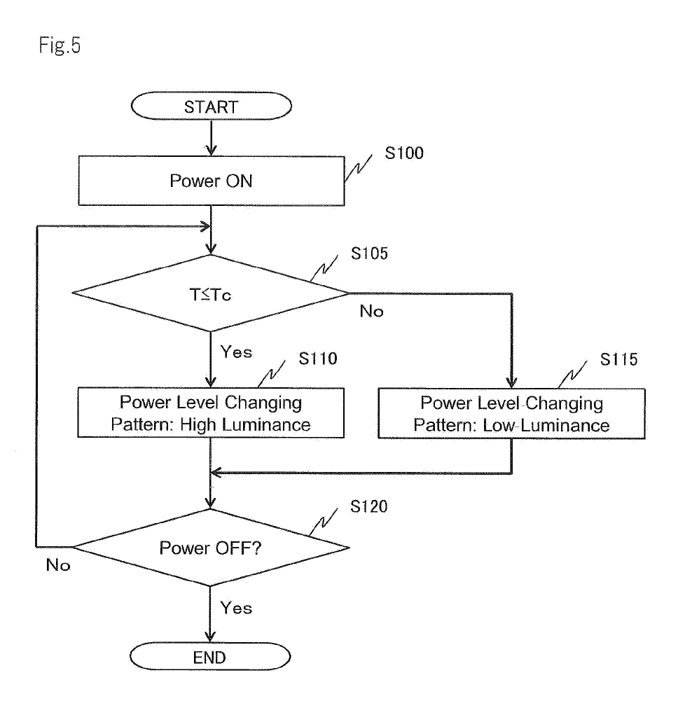

FIG. 5 is a flow chart for explaining the lamp power regulating process of projector 100 according to the present exemplary embodiment.

When the user presses down the power button (not shown), power supply 25 supplies power to each part of projector 100 to activate the diverse parts in projector 100 (Step S100).

Controller 27 acquires the measurement of temperature T detected by thermometer 22 and compares the detected temperature T with predetermined temperature Tc (Step S105). Here, temperature Tc is the threshold for determining whether or not the low-luminance pattern should be selected as the pattern of changing the power to be supplied to lamp 11, and is appropriately designated depending on the installed position of the thermometer, the cooling capacity of cooling fan 23 and the like. In this exemplary embodiment, Tc is set at 40 degrees.

When detected temperature T is equal to or lower than temperature Tc, controller 27 sets up the high-luminance pattern as the lamp power changing pattern, and changes the power level of the power to be supplied to lamp 11 in accordance with the high-luminance pattern by means of lamp power regulator 26 (Step S110).

On the other hand, when detected temperature T is higher than temperature Tc, controller 27 sets up the low-luminance pattern as the lamp power changing pattern, and changes the power level of the power to be supplied to lamp 11 in accordance with the low-luminance pattern by means of lamp power regulator 26 (Step S115).

Then, controller 27 determines whether or not an operation of turning off the power supply has been performed (Step S120).

When an operation of turning off the power supply has been performed, controller 27 sets power supply 25 into the OFF state so as to stop the supply of power. On the other hand, when no operation of turning off the power supply has been performed, controller 27 executes the process at Step S105 once again.

As described above, according to the present exemplary embodiment, changing the level of the power to be supplied to lamp 11 based on the ambient information is performed in synchronization with rotation of the color wheel. Thereby, the intensity of light that enters each transmission area of color wheel 12 changes in accordance with the ambient information. Accordingly, it is possible to lower the intensity of light that enters each part arranged on the optical path downstream of color wheel 12 and thus prevent an increase in the temperature of the parts.

Because this process does not need any shading member, it is possible to prevent luminance unevenness from occurring on the projected image. Further, since it is no longer necessary to continuously supply a power equal to or lower than a predetermined level to lamp 11 for a long time, it is possible to prevent a reduction in the lamp life cycle. As a result, it is possible to reduce the amount of deficiencies that occur in optical parts due to an increase in the temperature while preventing brightness unevenness from occurring and preventing any reduction in the lamp life cycle.

The effect of preventing an increase in the temperature varies depending on the power level changing pattern and the like. When DMD 13 has a heat resistance temperature of 80° C., and the maximum temperature rise of DMD 13 is assumed to be 40° C. when the high-luminance pattern is used as the power level changing pattern, the upper limit of the air temperature at which projector 100 can be used stably is 40° C. In contrast, when an increase in the temperature of DMD 13 can be reduced to 80% by switching the power level changing pattern from a high-luminance pattern to a low-luminance pattern, an increase in the temperature of DMD 13 can be reduced to 32° C.

In this case, the upper limit of the air temperature at which projector 100 can be used stably is 48° C. (80° C.−32° C.=48° C.), so that it is possible to achieve a gain of 8° C. compared to the case where the power level is changed in the high-luminance pattern.

### Second Exemplary Embodiment

The second exemplary embodiment will be described.

In the second exemplary embodiment, projector 100 has the same configuration as that in the first exemplary embodiment. The difference from the first exemplary embodiment will be described hereinbelow.

Controller 27 also changes, based on the temperature detected by thermometer 22, the average power level that is the average value of the supplied power per a frame in the video signal. Specifically, controller 27 reduces the average power level while keeping the ratio of the supplied power that is set for each transmission area constant, then changes the ratio of the supplied power when the temperature detected by thermometer 22 satisfies a predetermined condition. Herein, controller 27 determines that the predetermined condition is satisfied when the temperature detected by thermometer 22 exceeds a predetermined temperature. Controller 27 changes the ratio of the power level by switching the power level changing pattern as in the first exemplary embodiment.

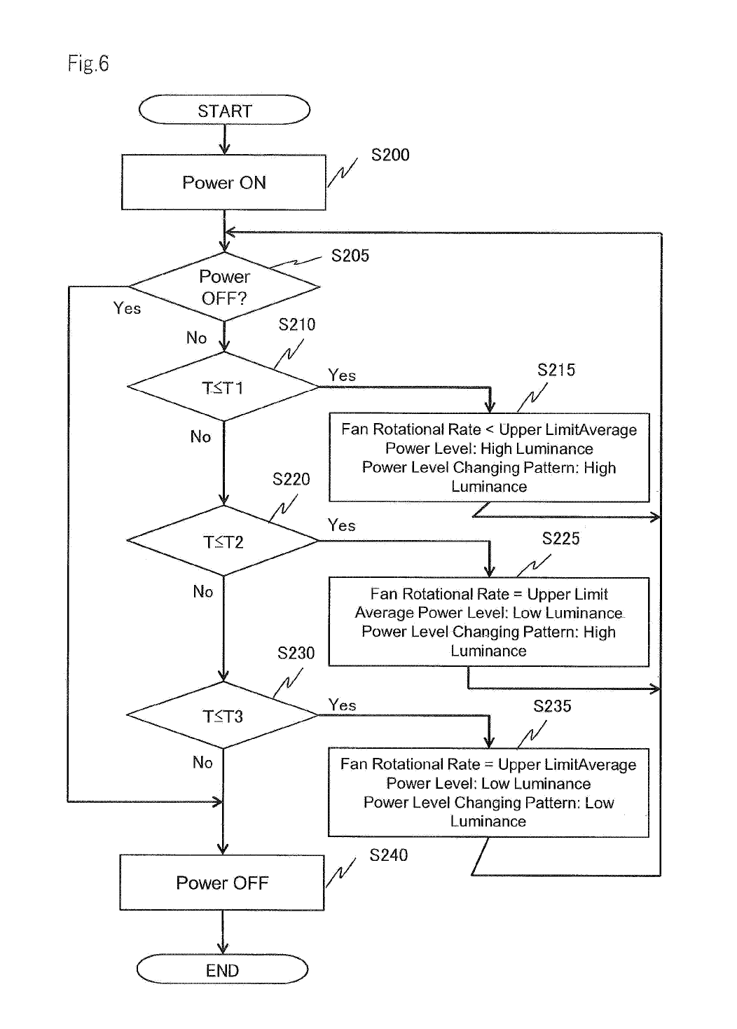

FIG. 6 is a flow chart for explaining the power regulation mode switching process of projector 100 according to the second exemplary embodiment of the present invention.

When the user presses down the power button, power supply 25 supplies power to each part of projector 100 to activate the diverse parts in projector 100 (Step S200).

Controller 27 determines whether or not a user's operation of turning off the power supply has been detected (Step S205).

When no operation of turning off the power supply has been detected, controller 27 acquires the measurement of temperature T detected by thermometer 22 and compares the detected temperature T with predetermined first temperature T1 (Step S210). First temperature T1 is the threshold for determining whether or not the average power level supplied to lamp 11 should be set at the low-luminance mode.

When detected temperature T is equal to or lower than first temperature T1, controller 27 sets the rotational rate of cooling fan 23 at a value not greater than the upper limit, sets the average power level at the high-luminance mode, and selects the high-luminance pattern for the power level changing pattern (Step S215). Then, controller 27 returns control to the process at Step S205.

On the other hand, when detected temperature T exceeds first temperature T1, controller 27 compares detected temperature T with predetermined second temperature T2 (Step S220). Second temperature T2 is the threshold that is higher than first temperature T1 and that is used to determine whether or not the low-luminance pattern should be selected as the power level changing pattern.

When detected temperature T is higher than first temperature T1 and not higher than second temperature T2, controller 27 sets the rotational rate of cooling fan 23 at the upper limit, sets the average power level at the low-luminance mode and uses the high-luminance pattern, as is, as the power level changing pattern (Step S225). Then, controller 27 returns control to the process at Step S205.

On the other hand, when detected temperature T exceeds second temperature T2, controller 27 compares detected temperature T with predetermined third temperature T3 (Step S230). Third temperature T3 is the threshold that is higher than second temperature T2 and that is used to determine whether or not the operation of projector 100 should be stopped.

When detected temperature T is higher than second temperature T2 and not higher than third temperature T3, controller 27 keeps the rotational rate of cooling fan 23 at the upper limit, keeps the average power level at the low-luminance mode and selects the low-luminance pattern for the power level changing pattern (Step S235). Then, controller 27 returns control to the process at Step S205.

On the other hand, when detected temperature T exceeds third temperature T3, or when an operation of turning off the power supply has been detected at Step S205, controller 27 stops the power supply from supplying power to lamp 11 (Step S240).

As described above, also in this exemplary embodiment, changing the level of the power to be supplied to lamp 11 based on the ambient information is performed in synchronization with rotation of the color wheel. Accordingly, it is possible to prevent luminance unevenness from occurring and to prevent a reduction in the lamp life cycle and it is also possible to prevent the occurrence of deficiencies in optical parts that result from an increase in temperature, similarly to the first exemplary embodiment.

Further, in the present exemplary embodiment, based on the temperature detected by thermometer 22, the average level of power supplied to lamp 11 is changed. As a result, it is possible to reliably lower the total amount of light that passes through color wheel 12.

In the present exemplary embodiment, when the detected temperature satisfies the predetermined condition after the average power level has been lowered to the predetermined lower limit, the power level changing pattern is switched. As a result, it is possible to reduce deficiencies in optical parts that occur due to an increase in temperature when cooling is insufficient even after the average power level has been lowered to the lower limit.

Although the present invention has been explained with reference to the exemplary embodiments, the present invention should not be limited to the above exemplary embodiments. Various modifications that can be understood by those skilled in the art may be made to the structures and details of the present invention within the scope of the present invention.

For example, in the above exemplary embodiments, the basic configuration of projector 100 is shown in FIG. 1, however, the present invention should not be limited to this example. FIG. 1 shows a partial configuration of projector 100 in order to explain the exemplary embodiments of the present invention. For example, projector 100 should have optical parts such as lenses for conducting light, mirrors for deflecting the optical path and others, arranged on the optical path in which light emitted from lamp 11 is projected to screen 200 by way of projection lens 14.

Further, as to the configuration of transmission areas on color wheel 12, the configuration shown in FIG. 2 is a mere example, and the present invention should not be limited to this example.

Although the above exemplary embodiments have been explained with projector 100 having single lamp 11 and single color wheel 12, the present invention should not be limited to this example. The number and kind of lamps can be changed as appropriate. Further, the above technology can be applied to a projector having a plurality of color wheels 12. For example, when a plurality of color wheels 12 that turn about an identical rotational axis are used and light from lamp 11 passes through multiple transmission areas, the power level is changed in accordance with the system transmittance that is represented as a ratio of the amount of light outgoing from the last passing transmission area to the amount of light incident on the first passing transmission area.

Although the above exemplary embodiments have been explained using, as a detector that detects ambient information, thermometer 22 that detects temperature, the detector may be a barometer to detect air pressure that is used as the ambient information, an airflow meter to detect airflow that is used as the ambient information, or an anemometer to detect wind speed that is used as the ambient information. In this case, projector 100 includes a barometer, airflow meter or anemometer instead of thermometer 22 or in addition to thermometer 22.

Air pressure is low and air is thin at high altitudes. Accordingly, when projector 100 is used at high altitude environment, cooling fan 23 cannot adequately diffuse heat into the air, which results in poor cooling efficiency. Therefore, when air pressure is used as the ambient information, controller 27 can determine that the predetermined condition is satisfied when the air pressure becomes lower than a predetermined air pressure.

The airflow or wind speed inside projector 100 changes depending on the settings and capacity of cooling fan 23. For example, when the capacity of cooling fan 23 has degraded due to aging or when cooling fan 23 has been clogged due to dust and the like, the airflow or wind speed lowers. Therefore, when airflow or wind speed is used as the ambient information, controller 27 can determine that the predetermined condition is satisfied when the airflow or wind speed becomes lower than a predetermined value.

When, for example, plural pieces of information are used as the ambient information, plural conditions may be used in combination as the condition for switching power level changing patterns. For example, when air temperature and airflow are used as the ambient information, the power level changing pattern can be switched when either air temperature or airflow satisfies the predetermined condition. Alternatively, when air pressure and air temperature are used as the ambient information, the power level changing pattern can be switched when air pressure is equal to or lower than a predetermined threshold and when air temperature is equal to or higher than a predetermined threshold.

Although in the above exemplary embodiments a power level changing pattern is selected from among a plurality of predetermined patterns to change the timings at which the level of the power to be supplied to lamp 11 is changed and to change the values, the present invention should not be limited to this example. For example, controller 27 may calculate power levels as required.

### DESCRIPTION OF REFERENCE NUMERALS

100 projector (projection type display apparatus)

11 lamp (light source)

12 color wheel

13 DMD (display unit)

14 projection lens

21 display controller

22 thermometer (detector)

23 cooling fan

24 driving unit

25 power supply

26 lamp power regulator (power supplier)

27 controller

200 screen

1. A projection type display apparatus comprising:
a light source;
a light separation device that includes a plurality of transmission areas on which light from the light source is made incident and which each transmit light of a different wavelength;
a detector that detects ambient information;
a power supplier that supplies power to the light source; and
a controller that controls a supply power to be supplied to the light source by the power supplier, wherein
the transmission areas, on which light from the light source is made incident, are sequentially changed, and
when the ambient information satisfies a predetermined condition, the controller changes the supply power in synchrony with changes in the plurality of transmission areas.

2. The projection type display apparatus according to claim 1, wherein when the ambient information satisfies the predetermined condition, the controller changes the supply power so as to reduce a total amount of light that passes through the light separation device compared to the case where the ambient information does not satisfy the predetermined condition.

3. The projection type display apparatus according to claim 1, wherein when the ambient information satisfies the predetermined condition, the higher the transmittance of the transmission area, on which light from the light source is made incident, the greater is the reduction, by the controller, in the amount of the supply power.

4. The projection type display apparatus according to claim 1, wherein
the detector detects the temperature inside or around the projection type display apparatus to be used as the ambient information, and
the controller determines that the ambient information satisfies the predetermined condition when the temperature detected by the detector exceeds a predetermined temperature.

5. The projection type display apparatus according to claim 1, wherein
the detector detects the air pressure inside or around the projection type display apparatus to be used as the ambient information, and
the controller determines that the ambient information satisfies the predetermined condition when the air pressure detected by the detector becomes lower than a predetermined temperature.

6. The projection type display apparatus according to claim 1, wherein
the detector detects the airflow or the wind speed inside the projection type display apparatus to be used as the ambient information, and
the controller determines that the ambient information satisfies the predetermined condition when the airflow or wind speed detected by the detector becomes lower than a predetermined airflow or wind speed.

7. The projection type display apparatus according to claim 1, further comprising an image forming device that modulates light that passes through the light separation device to form an image in accordance with a video signal, wherein
the controller, based on the ambient information, changes an average power level that is an average value of the supply power per frame in the video signal.

8. The projection type display apparatus according to claim 7, wherein the controller reduces the average power level to a predetermined lower limit while keeping a ratio of the supply power that is set for each transmission area constant, then changes the ratio when the ambient information satisfies a predetermined condition.

9. The projection type display apparatus according to claim 1, wherein the light separation device comprises a color wheel.

10. A control method for a projection type display apparatus, comprising:
emitting light from a light source;
making the light incident on a light separation device that includes a plurality of transmission areas that each transmit light of a different wavelength;
sequentially changing the transmission areas on which light from the light source is made incident;
detecting ambient information; and
changing a power that is supplied to the light source in synchrony with changes in the transmission areas, based on the ambient information.
